(19) United States
(12) Patent Application Publication
(10) Pub. No.: US 2013/0321608 A1
(43) Pub. Date: Dec. 5, 2013

(54) EYE DIRECTION DETECTING APPARATUS AND EYE DIRECTION DETECTING METHOD

(71) Applicant: JVC KENWOOD Corporation, Yokohama-shi (JP)

(72) Inventors: Masaru NINOMIYA, Yokohama-shi (JP); Shuji HAKOSHIMA, Machida-shi (JP)

(73) Assignee: JVC KENWOOD Corporation, Yokohama-shi (JP)

(21) Appl. No.: 13/901,217

(22) Filed: May 23, 2013

(30) Foreign Application Priority Data
May 31, 2012 (JP) 2012-125223

(51) Int. Cl. G06F 3/01

(52) U.S. Cl. CPC G06F 3/013
USPC 348/78

(57) ABSTRACT

An eye direction detecting apparatus includes a display unit, an imaging unit, a first detecting unit, a second detecting unit, and a display control unit. The imaging unit captures a subject. The first detecting unit detects a position of an eye of the subject from an image captured by the imaging unit. The second detecting unit detects a distance from the imaging unit to the position of the eye of the subject. The display control unit displays the image indicating the position of the eye of the subject on the display unit with a display manner being changed according to the distance detected by the second detecting unit.

### CROSS-REFERENCE TO RELATED APPLICATIONS

This application is based upon and claims the benefit of priority from Japanese Patent Application No. 2012-125223, filed on May 31, 2012, the entire contents of which are incorporated herein by reference.

### BACKGROUND OF THE INVENTION

1. Field of the Invention

The present invention relates to an eye direction detecting apparatus, and an eye direction detecting method.

2. Description of the Related Art

Since resolution of a camera has been enhanced, a processing speed of the camera has been increasing, and the camera has been downsized, there has been proposed an eye direction detecting apparatus that detects a position on an observation surface, such as on a monitor screen, which is gazed by a subject, from an image of a face captured by a camera. At the beginning, most of the proposed methods included a method of fixing a head of a subject, and a method of mounting a detecting apparatus on the head of the subject. In recent years, however, a non-contact apparatus has been developed in order to reduce burden on the subject, and an eye direction detecting apparatus having higher precision has been demanded. For example, Japanese Patent Application Laid-open No. 2005-185431 proposes a non-contact type eye direction detecting apparatus that detects an eye direction from a coordinate of a pupil and a corneal reflection.

In order to correctly detect an eye direction, it is necessary that a subject and a camera have a proper positional relationship. Therefore, it is important that whether or not the subject is located on a proper position with respect to the camera can easily be determined, and the position can be adjusted.

However, in the eye direction detecting apparatus of a non-contact type described in Japanese Patent Application Laid-open No. 2005-185431, as the subject can freely move, the precision in the detection result has not always been high. Accordingly, it is necessary that the subject is guided to a proper position in the eye direction detecting apparatus of a non-contact type, in particular.

### SUMMARY OF THE INVENTION

It is an object of the present invention to at least partially solve the problems in the conventional technology.

To solve the above described problems and achieve the object according to an aspect of the present invention, an eye direction detecting apparatus includes: a display unit; an imaging unit configured to image a subject; a first detecting unit configured to detect a position of an eye of the subject from an image captured by the imaging unit; a second detecting unit configured to detect a distance to the position of the eye of the subject from the imaging unit; and a display control unit configured to display an image representing the position of the eye of the subject corresponding to the position of the eye detected by the first detecting unit onto the display unit with a display manner being changed according to the distance detected by the second detecting unit.

According to another aspect of the present invention, an eye direction detecting apparatus includes: a display unit; an imaging unit configured to image a subject; a first detecting unit configured to detect a position of an eye of the subject from an image captured by the imaging unit; and a display control unit configured to display at least one of a reference image indicating a range of a reference region included in an imaging region of the imaging unit, an imaging-range image indicating a range of an imaging region, and an image representing the position of the eye of the subject on the display unit with a display manner being changed according to a positional relationship between a set region proper for detecting the position of the eye of the subject and the position of the eye of the subject.

According to still another aspect of the present invention, an eye direction detecting method includes: a position detecting step detecting a position of an eye of a subject from an image captured by an imaging unit that captures the subject; a distance detecting step detecting a distance from the imaging unit to the position of the eye of the subject; and a display control step displaying an image indicating the position of the eye of the subject on the display unit with a display manner being changed according to the distance detected in the distance detecting step.

According to still another aspect of the present invention, an eye direction detecting method includes: a position detecting step detecting a position of an eye of a subject from an image captured by an imaging unit that captures the subject; and a display control step displaying at least one of a reference image indicating a range of a reference region included in an imaging region of the imaging unit, an imaging-range image indicating a range of an imaging region, and an image representing the position of the eye of the subject with a display manner being changed according to a positional relationship between a set region proper for detecting the position of the eye of the subject and the position of the eye of the subject.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating one example of an arrangement of a display unit, a stereo camera, and a light source used in a first embodiment;

FIG. 2 is a view illustrating an outline of a function of an eye direction detecting apparatus according to the first embodiment;

FIG. 3 is a block diagram illustrating one example of a detailed function of each unit illustrated in FIG. 2;

FIG. 4 is a view illustrating one example an eye and distance detection, when two cameras are used;

FIG. 5 is a view illustrating one example of a screen that displays a result of detection as to whether a distance between a subject and a camera is proper or not;

FIG. 6 is a view illustrating a display example of a screen when the subject is on a position with a distance smaller than a reference distance dr;

FIG. 7 is a view illustrating a display example of a screen, when the position of the subject is proper;

FIG. 8 is a view illustrating one example of a relationship between a distance dz and a size of an eye position image;

FIG. 9 is a view illustrating another example of a relationship between the distance dz and the size of the eye position image;

FIG. 10 is a flowchart illustrating one example of a display control process in the first embodiment;

FIG. 11 is a flowchart illustrating one example of a display control process in a modification 1 of the first embodiment;

FIG. 12 is a view illustrating one example of a relationship between a distance dz and a display color of an eye position image;

FIG. 13 is a view illustrating one example of a relationship between a distance dz and a tone of an eye position image;

FIG. 14 is a view illustrating one example of a relationship among a distance dz, an eye position image, and a displayed character to be displayed;

FIG. 15 is a functional block diagram illustrating an example of a configuration of a control unit according to a second embodiment;

FIG. 16 is a view illustrating one example of a screen that displays a result of detection as to whether a distance between a subject and a stereo camera is proper or not in a calibration mode;

FIG. 17 is a view illustrating one example of a screen that displays a result of detection as to whether a distance between a subject and a stereo camera is proper or not in a calibration mode;

FIG. 18 is a view illustrating one example of a screen that displays a result of detection as to whether a distance between a subject and a stereo camera is proper or not in a calibration mode;

FIG. 19 is a view illustrating one example of a screen that displays a result of detection as to whether a distance between a subject and a stereo camera is proper or not in a measurement mode;

FIG. 20 is a view illustrating one example of a screen that displays a result of detection as to whether a distance between a subject and a stereo camera is proper or not in a measurement mode;

FIG. 21 is a view illustrating one example of a screen that displays a result of detection as to whether a distance between a subject and a stereo camera is proper or not in a measurement mode;

FIG. 22 is a flowchart illustrating one example of a display control process in the second embodiment;

FIG. 23 is a view illustrating one example of a screen that displays a result of detection as to whether a positional relationship between a subject and a stereo camera is proper or not in a calibration mode;

FIG. 24 is a view illustrating one example of a screen that displays a result of detection as to whether a positional relationship between a subject and a stereo camera is proper or not in a calibration mode;

FIG. 25 is a view illustrating one example of a screen that displays a result of detection as to whether a positional relationship between a subject and a stereo camera is proper or not in a calibration mode;

FIG. 26 is a view illustrating one example of a screen that displays a result of detection as to whether a positional relationship between a subject and a stereo camera is proper or not in a measurement mode;

FIG. 27 is a view illustrating one example of a screen that displays a result of detection as to whether a positional relationship between a subject and a stereo camera is proper or not in a measurement mode; and

FIG. 28 is a view illustrating one example of a screen that displays a result of detection as to whether a positional relationship between a subject and a stereo camera is proper or not in a measurement mode.

### DETAILED DESCRIPTION OF THE PREFERRED EMBODIMENTS

Embodiments of an eye direction detecting apparatus and an eye direction detecting method according to the present invention will be described in detail with reference to the drawings. The present invention is not limited by these embodiments.

### First Embodiment

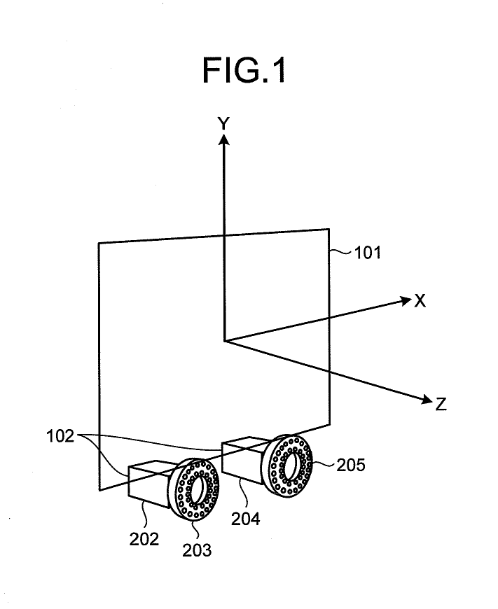

FIG. 1 is a view illustrating one example of an arrangement of a display unit, a stereo camera, and a light source used in a first embodiment. As illustrated in FIG. 1, a pair of stereo cameras 102 is arranged below a display screen 101 in the first embodiment. The stereo camera 102 is an imaging unit that can perform a stereo photographing by infrared ray, and includes a right camera 202 and a left camera 204.

Infrared LED (Light Emitting Diode) light sources 203 and 205 are arranged respectively just before the lens of each of the right camera 202 and the left camera 204 in the circumferential direction. The infrared LED light sources 203 and 205 include an inner peripheral LED and an outer peripheral LED, each emitting light of a different wavelength. The infrared LED light sources 203 and 205 detect a pupil of a subject. The method described in Japanese Patent Application Laid-open No. 2008-125619 may be used as the method of detecting a pupil, for example.

When an eye direction is detected, a position is specified by expressing a space with a coordinate. In the present embodiment, a central position on the display screen 101 is defined as an origin, a vertical direction is defined as a Y coordinate (the upward direction is positive), a lateral direction is defined as an X coordinate (the right direction is positive), and a depth direction is defined as a Z coordinate (the front direction is positive).

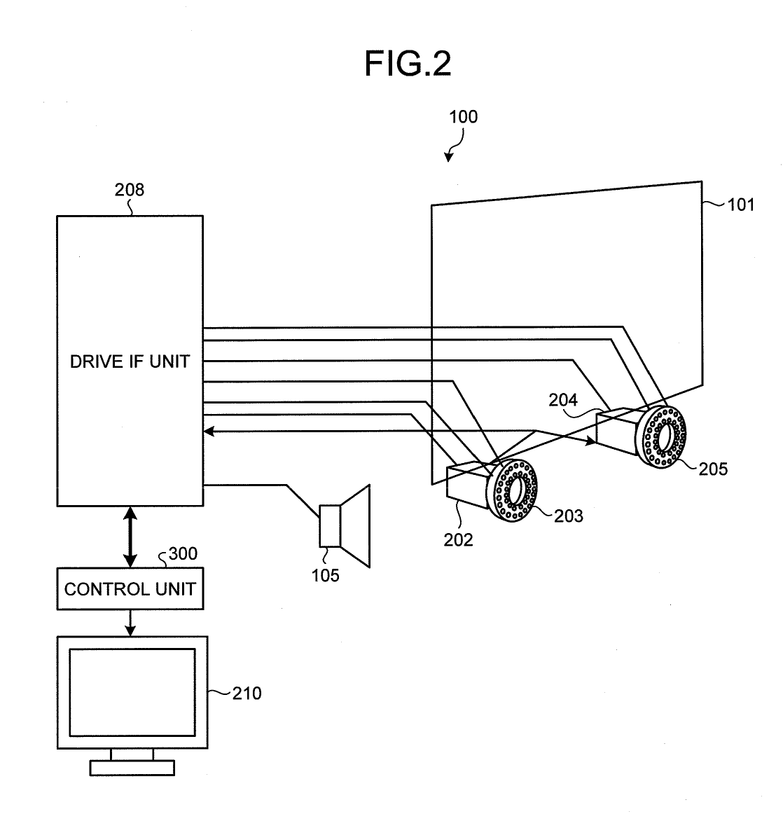

FIG. 2 is a view illustrating an outline of a function of an eye direction detecting apparatus 100. FIG. 2 illustrates a part of the configuration illustrated in FIG. 1, and a configuration used to drive this configuration. As illustrated in FIG. 2, the eye direction detecting apparatus 100 includes the right camera 202, the left camera 204, the infrared LED light sources 203 and 205, a speaker 105, a drive IF unit 208, a control unit 300, and a display unit 210. In FIG. 2, the display screen 101 illustrates the positional relationship between the right camera 202 and the left camera 204 in an easy-to-understand manner. The display screen 101 is a screen displayed on the display unit 210.

The speaker 105 outputs sound for calling a subject's attention during a calibration.

The drive IF unit 208 drives each unit included in the stereo camera 102. The drive IF unit 208 serves as an interface between the respective units included in the stereo camera 102 and the control unit 300.

The display unit 210 displays various pieces of information such as a subject image for an examination.

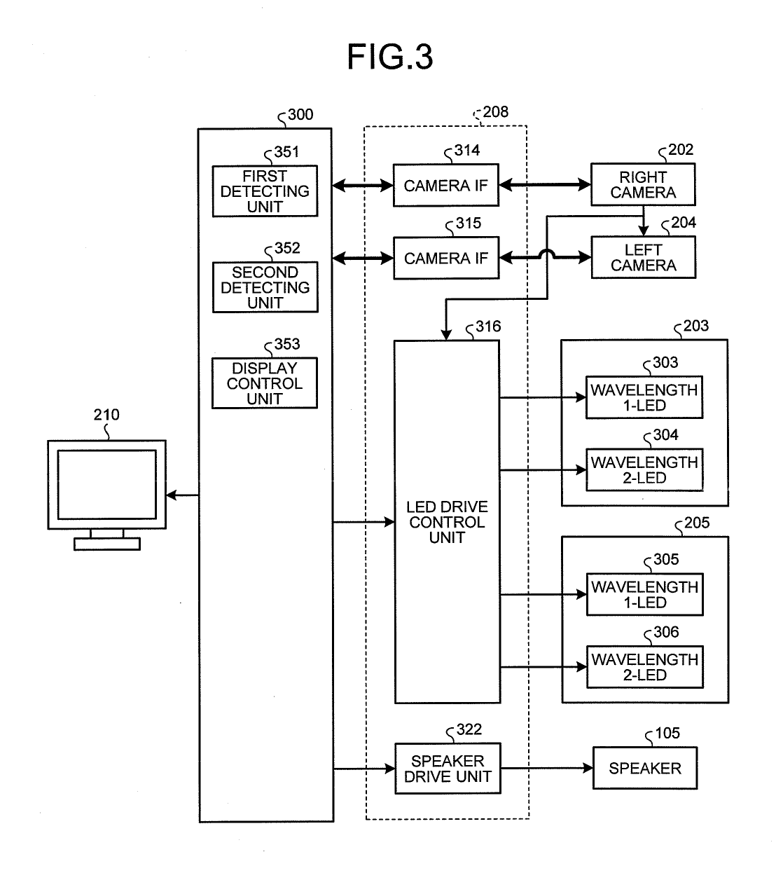

FIG. 3 is a block diagram illustrating one example of a detailed function of each unit illustrated in FIG. 2. As illustrated in FIG. 3, the display unit 210 and the drive IF unit 208 are connected to the control unit 300. The drive IF unit 208 includes camera IFs 314 and 315, an LED drive control unit 316, and a speaker drive unit 322.

The right camera 202 and the left camera 204 are connected to the drive IF unit 208 via the camera IFs 314 and 315 respectively. Since the drive IF unit 208 drives these cameras, the subject is imaged.

The right camera 202 outputs a frame synchronization signal. The frame synchronization signal is inputted to the left camera 204 and the LED drive control unit 316. Thus, on a first frame, the right and left infrared light sources (wavelength 1—LED 303, wavelength 1—LED 305) emit light with a wavelength 1 by delaying the timing, and with this, the images by the right and left cameras (right camera 202, left camera 204) are taken. On a second frame, the right and left infrared light sources (wavelength 2—LED 304, wavelength 2—LED 306) emit light with a wavelength 2 by delaying the timing, and with this, the images by the right and left cameras are taken.

The infrared LED light source 203 includes the wavelength 1—LED 303, and the wavelength 2—LED 304. The infrared LED light source 205 includes the wavelength 1—LED 305, and the wavelength 2—LED 306.

The wavelength 1—LEDs 303 and 305 emit infrared ray with the wavelength 1. The wavelength 2—LEDs 304 and 306 emit infrared ray with the wavelength 2.

The wavelength 1 is assumed to be less than 900 nm, and the wavelength 2 is assumed to be 900 nm or longer, for example. When the light reflected by the pupil is imaged with the irradiation of the infrared ray with the wavelength of less than 900 nm, a brighter pupil image can be acquired, compared to the case in which the light reflected by the pupil is imaged with the irradiation of the infrared ray with the wavelength of 900 nm or longer.

The speaker drive unit 322 drives the speaker 105.

The control unit 300 entirely controls the eye direction detecting apparatus 100, and outputs the result to the display unit 210, the speaker 105, and the like. The control unit 300 includes a first detecting unit 351, a second detecting unit 352, and a display control unit 353.

The first detecting unit 351 detects the eye direction of the subject from the image captured by the imaging unit (stereo camera 102). The process of detecting the eye direction includes a process of detecting the position of the eye of the subject. In the first embodiment, the first detecting unit 351 detects a viewpoint, which is a point gazed by the subject, among the subject image displayed onto the display screen 101, for example. Any methods conventionally used may be used for the method of detecting the viewpoint by the first detecting unit 351. The method of detecting the viewpoint of the subject by using the stereo camera as described in Japanese Patent Application Laid-open No. 2005-198743 will be described below.

In this case, the first detecting unit 351 detects the eye direction of the subject from the image captured by the stereo camera 102. The first detecting unit 351 detects the eye direction of the subject by using the method described in Japanese Patent Application Laid-open No. 2005-185431 and Japanese Patent Application Laid-open No. 2008-125619, for example. Specifically, the first detecting unit 351 obtains a difference between an image captured with the irradiation of the infrared ray having the wavelength 1 and an image captured with the irradiation of the infrared ray having the wavelength 2, thereby generating an image on which a pupil image is made clear. The first detecting unit 351 calculates the position of the pupil (the position of the eye) of the subject according to a stereoscopic technique by using two images generated respectively from the images captured by the right and left cameras (right camera 202, left camera 204). The first detecting unit 351 also calculates the position of the corneal reflection of the subject by using the images captured by the right and left cameras. The first detecting unit 351 then calculates an eye-direction vector, indicating the eye direction of the subject, from the position of the pupil of the subject and the position of the corneal reflection.

The method of detecting the position of the eye and the eye direction of the subject is not limited thereto. For example, the position of the eye and the eye direction of the subject may be detected by analyzing an image captured with a visible light, not with infrared ray.

The second detecting unit 352 detects the distance from the imaging unit (stereo camera 102) to the position of the eye of the subject. In the first embodiment, the second detecting unit 352 detects a distance dz in the depth direction (Z coordinate direction) between the stereo camera 102 and the eye of the subject as the distance between the imaging unit (stereo camera 102) and the position of the eye of the subject.

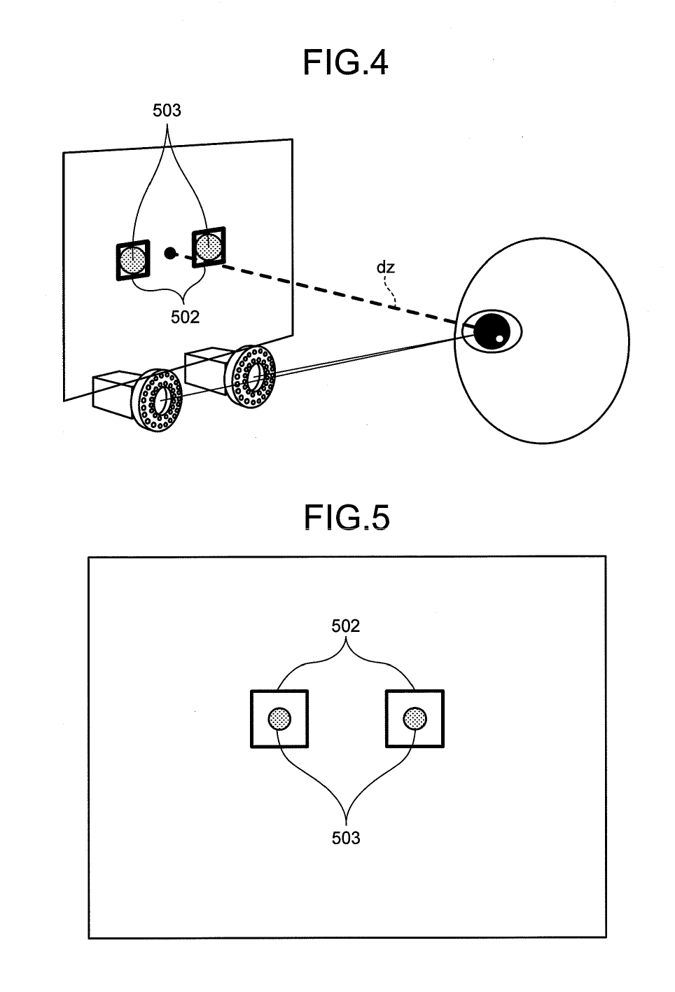

FIG. 4 is a view illustrating one example of detecting an eye and a distance, when two cameras (right camera 202, left camera 204) are used. Camera parameters of two cameras are preliminarily obtained by applying a camera calibration theory according to a stereo calibration. Any methods conventionally used, such as a method using Tsai camera calibration theory, can be used for the stereo calibration method. A three-dimensional coordinate on a world coordinate system can be obtained by using the position of the eye detected from the image captured by the right camera 202, the position of the eye detected from the image captured by the left camera 204, and the camera parameters. Thus, the distance between the eye and the stereo camera 102, and the pupil coordinate can be estimated. The pupil coordinate is a coordinate value indicating the position of the eye (pupil) of the subject on an XY plane. The pupil coordinate may be the coordinate value formed by projecting the position of the eye, represented by the world coordinate system, onto the XY plane. In general, the pupil coordinates both of the right and left eyes are obtained.

Markers 502 and eye position images 503 are displayed on the display screen 101. The eye position image 503 is an image indicating the position of the eye of the subject. The marker 502 is an image corresponding to a size of the eye position image 503 of the subject on a predetermined reference distance. FIG. 4 illustrates the rectangular markers. However, the shape of the marker 502 is not limited to rectangle. For example, the marker may have a polygonal shape other than a rectangular (square) shape, a circular shape, or an elliptic shape.

When the coordinate system (world coordinate system) illustrated in FIG. 1 is used, the central position of the display screen 101 is an origin. Therefore, the Z coordinate value of the detected eye position corresponds to the distance dz in the depth direction between the stereo camera 102 and the eye of the subject. The distance may be calculated from the actual position of the stereo camera 102 and the position of the eye of the subject calculated by the first detecting unit 351. For example, the second detecting unit 352 may detect the distance to the eye of the subject from either one of the position of the right camera 202 and the position of the left camera 204, or from the middle position between the right camera 202 and the left camera 204.

The display control unit 353 displays the eye position image 503 of the subject on the display screen 101 by changing the display manner according to the distance detected by the second detecting unit 352. The display control unit 353 displays the eye position image 503 on the display screen 101 with the size of the eye position image being changed according to the distance. The display manner is not limited to the size (described later).

FIGS. 5 to 7 are views illustrating one example of a screen that displays a result of detection as to whether the distance between the subject and the stereo camera 102 is proper or not, before the actual detection of the eye direction. When the subject is on a place where he/she is caught by the stereo camera 102 in front of the display screen 101, the first detecting unit 351 calculates the pupil coordinate (X, Y) from the pupil image detected by the stereo camera 102. The second detecting unit 352 calculates the distance dz between the stereo camera 102 and the pupil in the depth direction (Z coordinate). When the distance dz falls within a range of the reference distance dr±A (dr−A≦dz≦dr+A), it can be said that the subject is present on a proper position for the detection of the eye direction. A is a fixed value that indicates a permissible range, and is set beforehand, for example.

The marker 502 is a square marker having a fixed size and having the center of the detected pupil as its center. The eye position image 503 is an image representing the eye position with a circle with the center of the pupil position being defined as its center. When the distance dz coincides with the reference distance dr, the display control unit 353 displays the eye position image 503 whose diameter coincides with the length of the side of the marker 502.

When the eye position is far from the position with the reference distance dr, i.e., when the distance dz is larger than the reference distance dr, the display control unit 353 displays the eye position image 503 whose diameter is smaller than the length of the side of the marker 502 according to the distance dz. When the eye position is closer than the position with the reference distance dr, i.e., when the distance dz is smaller than the reference distance dr, the display control unit 353 displays the eye position image 503 whose diameter is larger than the length of the side of the marker 502 according to the distance dz. The display control unit 353 changes the diameter of the eye position image 503 in proportion to the distance dz, for example.

Thus, the diameter of the eye position image 503 is changed in proportion to the distance dz, for example. Therefore, the subject can intuitively understand that he/she is on the position far from the position with the reference distance dr, when the size of the eye position image 503 is smaller than the marker 502, and that he/she is on the position closer than the position with the reference distance dr, when the size of the eye position image 503 is larger than the marker 502. Accordingly, the subject can adjust his/her position in order to have the reference distance dr.

FIG. 5 is a view illustrating a display example of the display screen 101 when the subject is on the position farther than the position of the reference distance dr. It is represented that the distance dz is farther than the reference distance dr, since the size of the eye position image 503 is smaller than the marker 502.

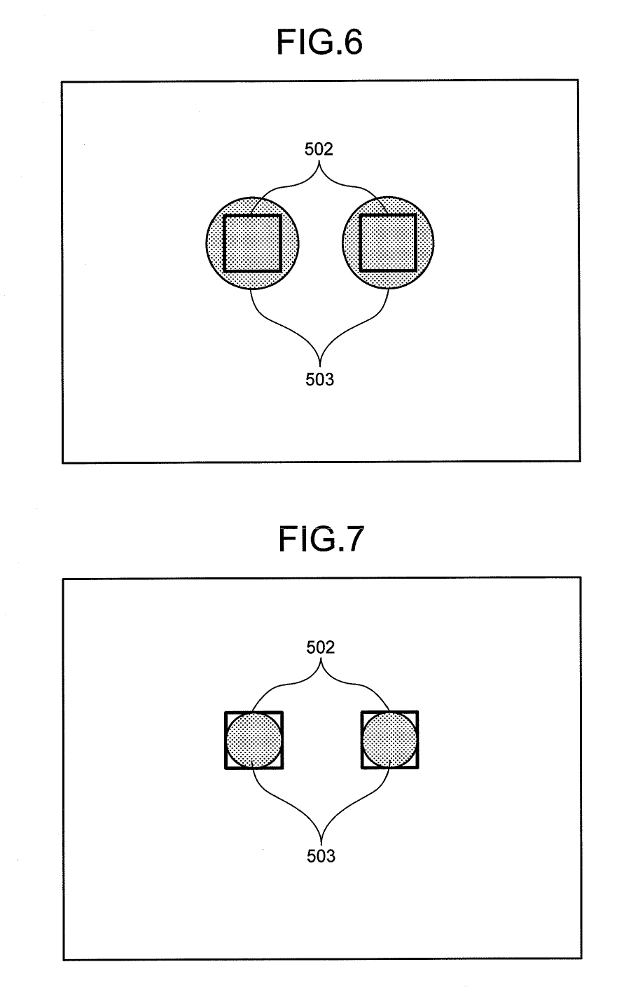

FIG. 6 is a view illustrating a display example of the display screen 101 when the subject is on the position closer than the position with the reference distance dr. It is represented that the distance dz is smaller than the reference distance dr, since the size of the eye position image 503 is larger than the marker 502.

FIG. 7 is a view illustrating a display example of the display screen 101, when the position of the subject is proper. FIG. 7 illustrates that the length of a side of the marker 502 and the diameter of the eye position image 503 coincide with each other.

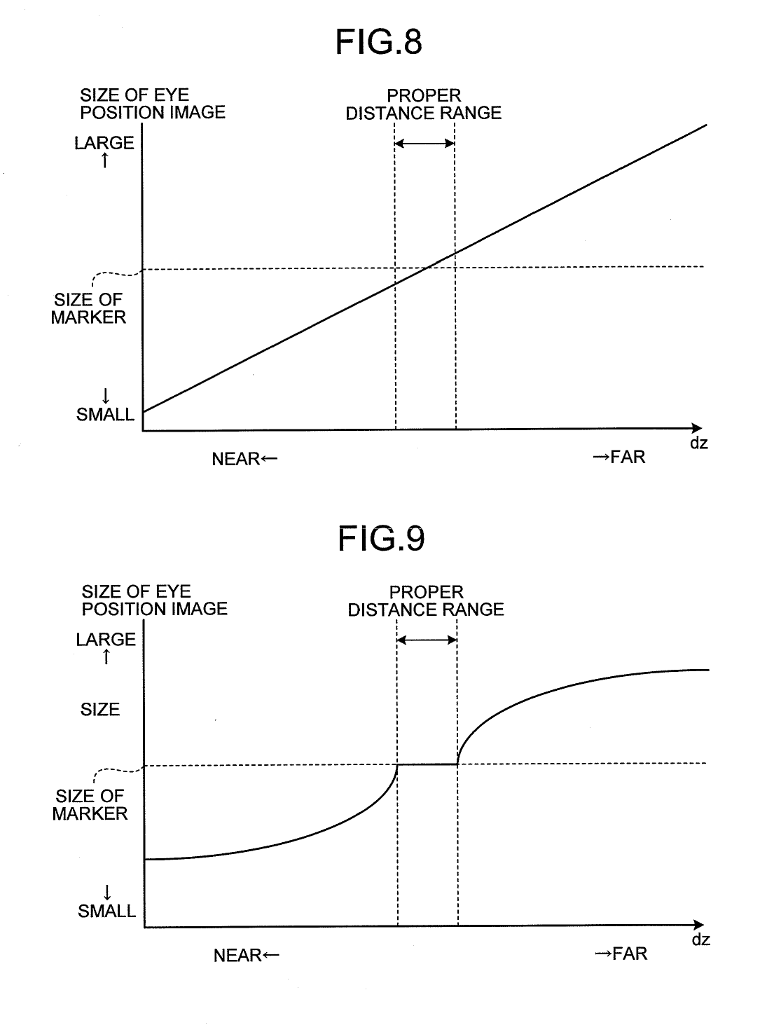

FIG. 8 is a view illustrating one example of a relationship between the distance dz and the size of the eye position image 503. FIG. 8 illustrates that the distance dz and the size of the eye position image 503 bear a proportionate relationship. FIG. 9 is a view illustrating another example of a relationship between the distance dz and the size of the eye position image 503. FIG. 9 illustrates that, when the distance dz falls within a proper range (e.g., dr±A), the eye position image 503 is displayed with the size same as or almost same as the marker 502, and when the distance dz is shifted from the proper range, the size of the eye position image 503 is changed according to the shifted distance. In FIG. 9, when the distance dz is out of the proper range, the relationship between the distance dz and the size of the eye position image 503 is non-linear. The relationships in FIGS. 8 and 9 are only illustrative, and the present invention is not limited thereto. For example, when the distance dz is out of the proper range in FIG. 9, the relationship between the distance dz and the size of the eye position image 503 may be proportional.

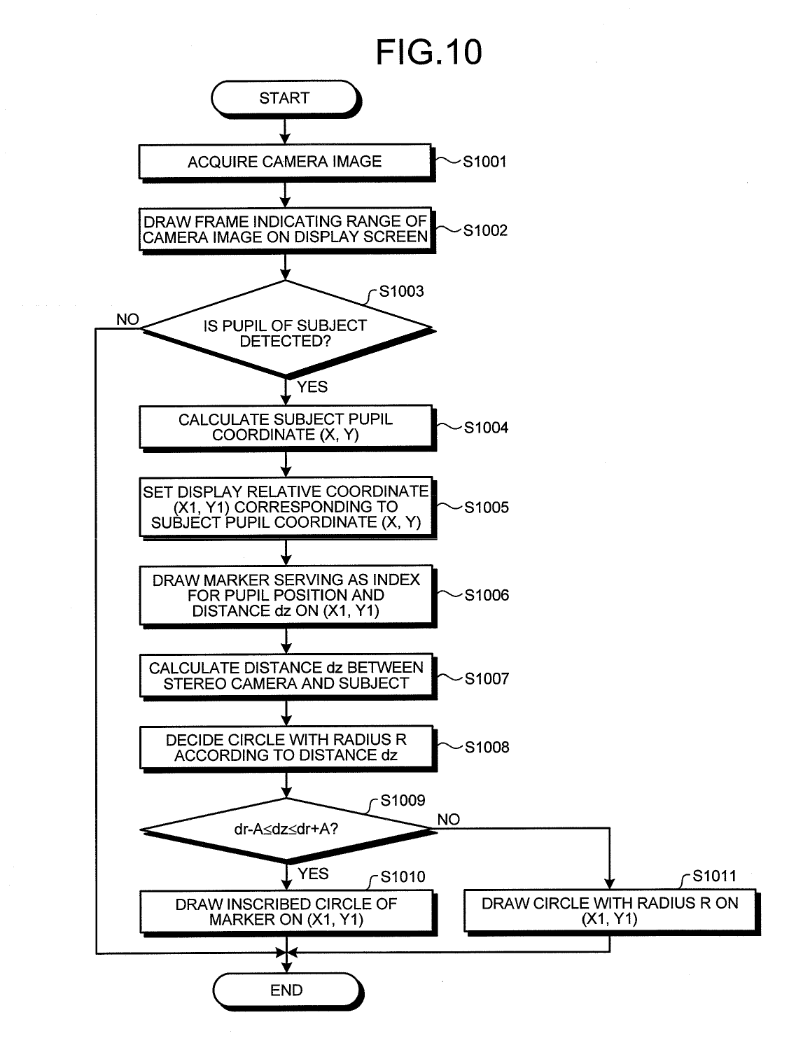

The display control process by the eye direction detecting apparatus 100 thus configured according to the first embodiment will next be described. The display control process is a process of detecting whether the distance between the subject and the stereo camera 102 is proper or not, and displaying the result, prior to the actual process of detecting an eye direction. FIG. 10 is a flowchart illustrating one example of the display control process in the first embodiment.

Firstly, when the subject is on the position where he/she is caught by the stereo camera 102 in front of the display screen 101, the first detecting unit 351 acquires the camera image including the pupil image detected by the stereo camera 102 (step S1001). The display control unit 353 draws a frame, indicating the range of the camera image, onto the display screen 101 (step S1002). The frame indicating the camera image may not be displayed unlike illustrated in FIGS. 4 to 7.

The first detecting unit 351 determines whether the pupil of the subject is detected or not from the camera image (step S1003). When the pupil of the subject is not detected for reasons the subject not being on a proper position or the like (step S1003: No), the display control process is ended.

When the pupil of the subject is detected (step S1003: Yes), the first detecting unit 351 calculates the pupil coordinate (X, Y) (step S1004). The display control unit 353 sets a display relative coordinate (X1, Y1) corresponding to the pupil coordinate (X, Y) of the subject in the frame indicating the range of the camera image (step S1005). The display relative coordinate is a coordinate representing the position of the image to be displayed on the display screen 101. For example, the coordinate system in which an upper-left corner of the display screen 101 is set as an origin, the vertical direction is set as the Y coordinate (the downward direction is positive), and the lateral direction is set as the X coordinate (the right direction is positive) may be used as the display relative coordinate. The display control unit 353 draws the marker 502 serving as index and having a fixed size around the display relative coordinate (X1, Y1) (step S1006).

The second detecting unit 352 calculates the distance dz between the stereo camera 102 and the pupil in the depth direction (step S1007).

The display control unit 353 decides a radius R of a circle representing the eye position image 503 according to the distance dz (step S1008). For example, when the distance dz and the size of the eye position image 503 have the relationship illustrated in FIG. 9, the display control unit 353 decides the radius R of the eye position image 503 (circle) corresponding to the distance dz according to this relationship.

Then, the display control unit 353 determines whether the distance dz falls within the prescribed range, i.e., whether the distance dz satisfies dr−A≦dz≦dr+A or not (step S1009). When the distance dz falls within the prescribed range (step S1009: Yes), the display control unit 353 draws the inscribed circle (eye position image 503) of the marker 502 as illustrated in FIG. 7 (step S1010). When the distance dz and the size of the eye position image 503 have the relationship illustrated in FIG. 8, the display control unit 353 draws the inscribed circle (the eye position image 503) of the marker 502, in case where the distance dz coincides with the reference distance dr.

When the distance dz is out of the prescribed range (step S1009: No), the display control unit 353 draws the circle (the eye position image 503) with the radius R on the display relative coordinate (X1, Y1) (step S1011). For example, when the distance dz is smaller than the reference distance dr−A, the display control unit 353 displays a small circle with the size in proportion to the distance dz in the marker 502 as illustrated in FIG. 5. When the distance dz is larger than the reference distance dr+A, the display control unit 353 displays a large circle with the size in proportion to the distance dz at the outside of the marker 502 as illustrated in FIG. 6.

The process in the flowchart in FIG. 10 is repeatedly executed sequentially. Thus, the display manner of the eye position image 503 is sequentially changed in accordance with the change in the position of the subject and the change in the distance dz.

Modification 1

In the embodiment described above, the size of the eye position image 503 is changed, as the display manner, according to the distance. In the modification 1, the color of the eye position image 503 is changed according to the distance. In the modification 1, the color of the eye position image 503 is changed. However, not only the color but also brightness may be changed. In the modification 1, the color of the eye position image 503 is changed between the case where the distance dz is not the reference distance dr (or when the distance dz is outside the prescribed range), and the case where the distance dz is the reference distance dr (or when the distance dz falls within the prescribed range). Thus, the subject can confirm whether he/she is on the position with the reference distance dr or not by adjusting his/her position.

When the distance dz is larger than the reference distance dr, for example, the display control unit 353 displays the eye position image 503 with a color of yellow. When the distance dz is shorter than the reference distance dr, for example, the display control unit 353 displays the eye position image 503 with a color of red. When the distance dz coincides with the reference distance dr, for example, the display control unit 353 displays the eye position image 503 with a color of green. Accordingly, the subject can determine whether or not he/she is on the position with the reference distance dr. Any color and any color combination of the eye position image 503 may be used, and the present invention is not limited to the above-mentioned example.

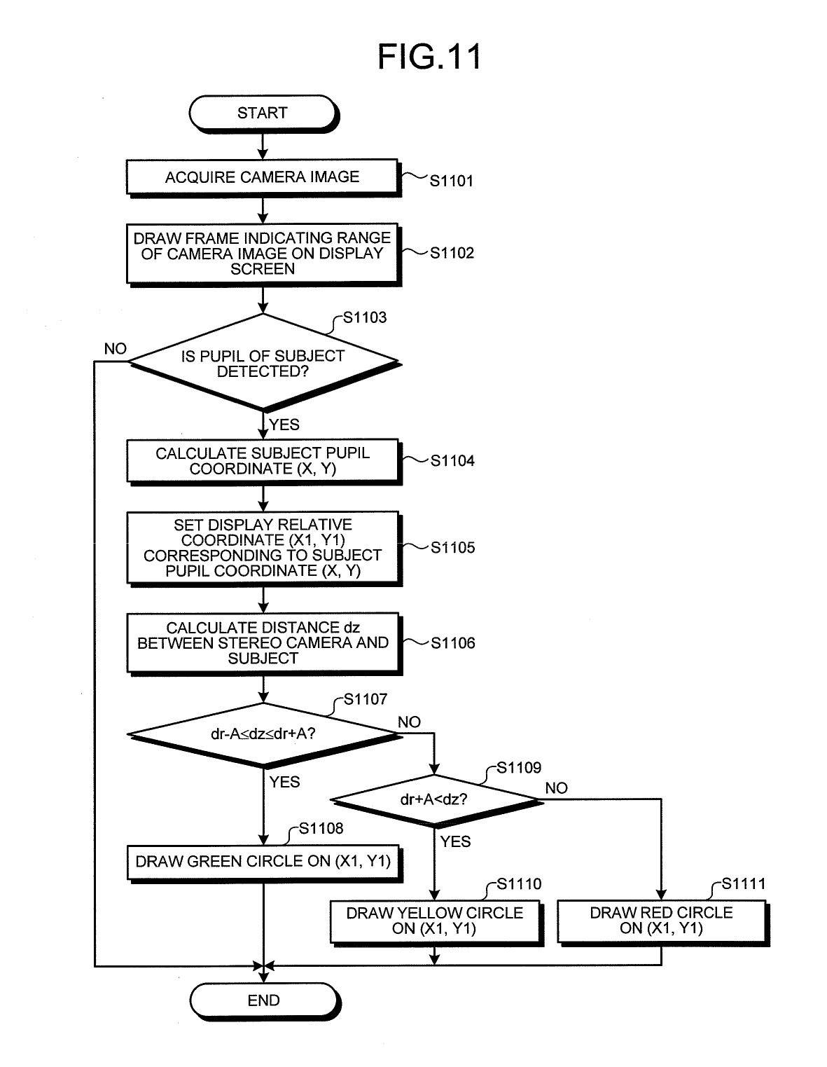

FIG. 11 is a flowchart illustrating one example of the display control process in the modification 1.

The processes in step S1101 to S1105 are the same as the processes in steps S1001 to S1005 in FIG. 10 for the display control process according to the first embodiment. Therefore, these processes will not be described below.

The second detecting unit 352 calculates the distance dz between the stereo camera 102 and the pupil in the depth direction (step S1106). Then, the display control unit 353 determines whether the distance dz falls within the prescribed range, i.e., whether the distance dz satisfies dr−A≦dz≦dr+A or not (step S1107). When the distance dz falls within the prescribed range (step S1107: Yes), the display control unit 353 draws a green circle (eye position image 503) on the display relative coordinate (X1, Y1) (step S1108).

When the distance dz is out of the prescribed range (step S1107: No), the display control unit 353 determines whether or not the distance dz is farther than the prescribed range, i.e., whether or not the distance dz satisfies dr+A<dz (step S1109). When the distance dz is farther than the prescribed range (step S1109: Yes), the display control unit 353 draws a yellow circle (eye position image 503) on the display relative coordinate (X1, Y1) (step S1110). When the distance dz is not farther than the prescribed range (step S1109: No), the display control unit 353 draws a red circle (eye position image 503) on the display relative coordinate (X1, Y1) (step S1111).

The process in the flowchart in FIG. 11 is repeatedly executed sequentially. Thus, the display manner of the eye position image 503 is sequentially changed in accordance with the change in the position of the subject and the change in the distance dz.

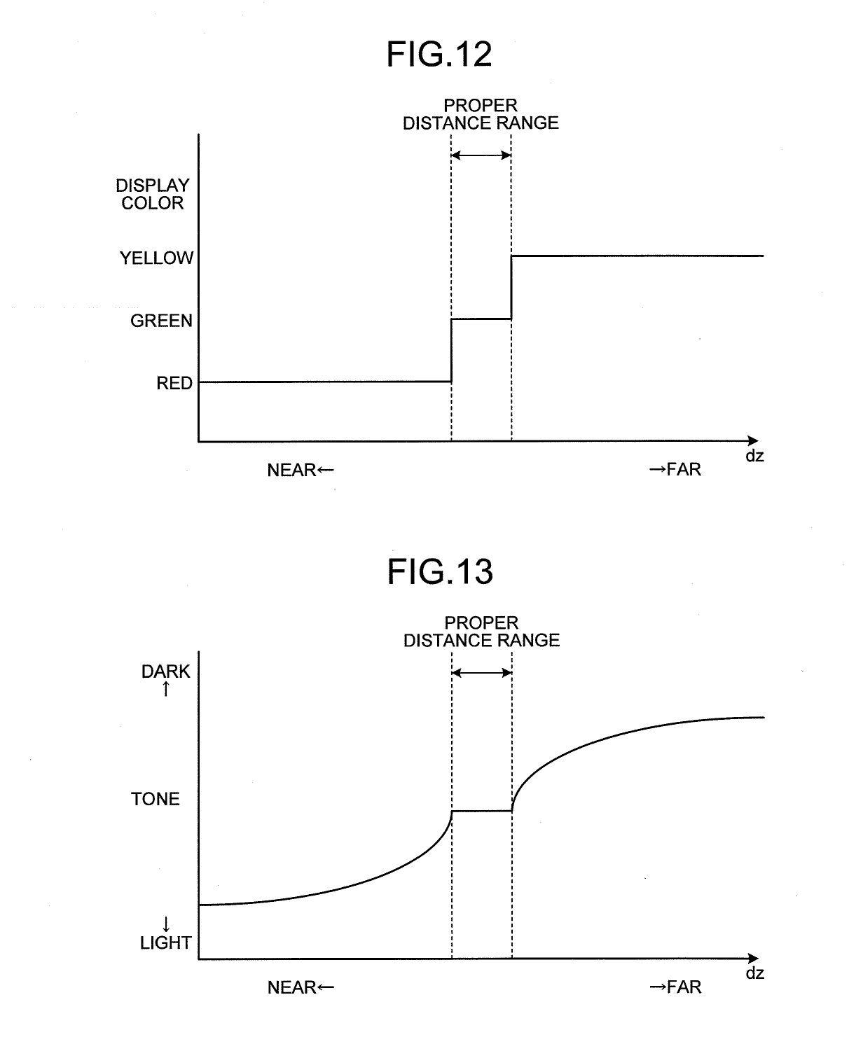

FIG. 12 is a view illustrating one example of a relationship between the distance dz and a display color of the eye position image 503. As illustrated in FIG. 12, when the distance dz falls within the proper range (e.g., within the range of dr±A), the display control unit 353 displays the eye position image 503 with green.

The display manner of the eye position image 503 changed according to the distance dz is not only a color, but may be a tone of an image, brightness of the image, and a character, symbol, or a graphic included in the image.

FIG. 13 is a view illustrating one example of a relationship between the distance dz and a tone of the eye position image 503. As illustrated in FIG. 13, when the distance dz falls within the proper range (e.g., within the range of dr±A), the display control unit 353 displays the eye position image 503 with medium tone. When the distance dz is shorter than the proper range, the display control unit 353 displays the eye position image 503 with a light tone. When the distance dz is larger than the proper range, the display control unit 353 displays the eye position image 503 with a dark tone.

In the modification 1, the display color of the eye position image 503 is changed. However, the display color or brightness of the marker 502 may be changed. The shape of the eye position image 503 is not limited to the circle, and any shape may be employed, so long as it appropriately represents the eye position.

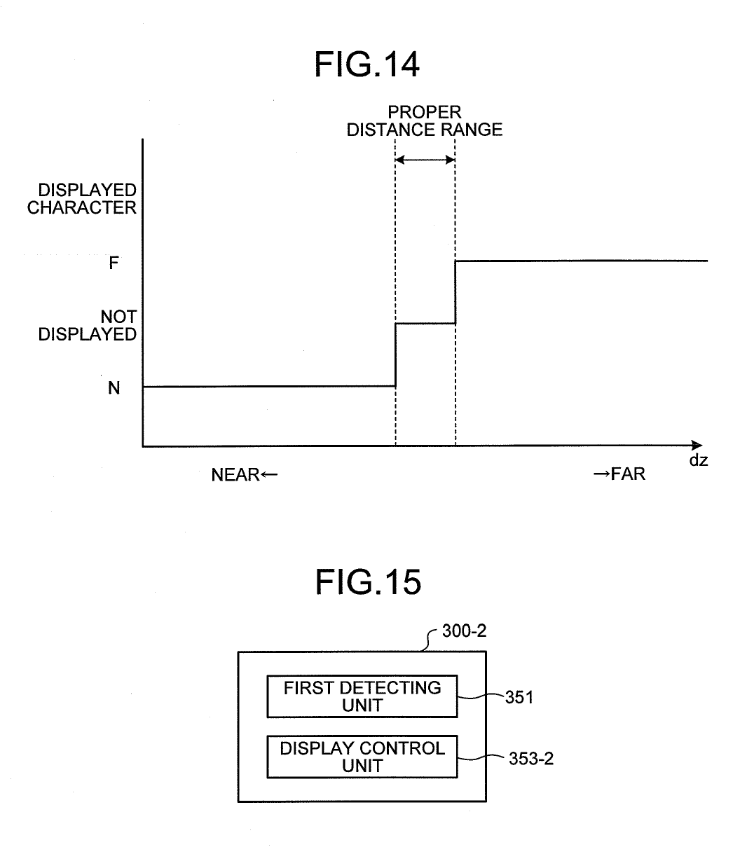

FIG. 14 is a view illustrating one example of a relationship among the distance dz, the eye position image 503, and a displayed character to be displayed. As illustrated in FIG. 14, when the distance dz falls within the proper range (e.g., within the range of dr±A), the display control unit 353 does not display the displayed character. When the distance dz is shorter than the proper range, the display control unit 353 displays “N” as the displayed character. When the distance dz is farther than the proper range, the display control unit 353 displays “F” as the displayed character. The displayed character is only illustrative, and the present invention is not limited thereto.

The processes described in FIGS. 10 and 11 may be executed simultaneously. Specifically, the size of the eye position image 503 is changed based upon the characteristics in FIG. 8 or 9 according to the distance between the subject and the stereo camera 102, and further, any one of the display manners illustrated in FIGS. 12 to 14 may be applied.

As described above according to the first embodiment effects as described below are obtained, for example.

(1) When the position of the subject is farther than the proper position, the image representing the eye becomes smaller than the marker 502, and when the position of the subject is closer than the proper position, the image representing the eye becomes larger than the marker 502. Accordingly, the subject can instantaneously determine whether he/she is far from the camera or close to the camera, and can adjust his/her position.
(2) When the subject is on the proper position, the color or brightness of the image representing the eye is changed. Therefore, the subject can instantaneously determine whether he/she is on the proper position or not, and can prepare for the start of the eye-direction detection.
(3) An adjustment index can be displayed on a position matching the point of gaze near the center of the monitor (display unit) screen. Therefore, the higher-precise result of the eye-direction detection can be acquired, compared to the method of displaying the position with a slide bar.

### Second Embodiment

In the first embodiment, the display manner of the eye position image is changed according to the distance between the imaging unit and the position of the eye of the subject, i.e., according to the position of the eye in the Z coordinate direction on the coordinate system in FIG. 1. In an eye direction detecting apparatus according to the second embodiment, the display manner of the eye position image is changed according to the position of the eye of the subject in the vertical direction and in the lateral direction with respect to the imaging unit, i.e., according to the position of the eye in the X coordinate and Y coordinate directions on the coordinate system in FIG. 1.

In the second embodiment, the function of a control unit 300-2 is different from the eye direction detecting apparatus 100 according to the first embodiment. The other functions of the eye direction detecting apparatus according to the second embodiment are the same as those of the eye direction detecting apparatus 100 illustrated in FIG. 2 according to the first embodiment, and the description will not be repeated. FIG. 15 is a functional block diagram illustrating an example of a configuration of the control unit 300-2 according to the second embodiment.

As illustrated in FIG. 15, the control unit 300-2 includes the first detecting unit 351, and a display control unit 353-2.

The display control unit 353-2 displays at least one of the eye position image of the subject, a reference image indicating a range of a reference region, and an imaging-range image indicating a range of an imaging region on the display screen 101, wherein the display manner is changed according to the positional relationship between a set region and the eye position of the subject. The reference region is included in the imaging region, and it is set beforehand as the region indicating a range of an appropriate position of the eye of the subject, for example. The region having a predetermined size in the imaging region including the center of the imaging region may be set as the reference region, for example. The set region indicates a region appropriate for detecting the eye position of the subject. For example, the reference region may be set as the set region, and the imaging region may be set as the set region.

The set region may be changed according to an operation mode of the eye direction detecting apparatus. The operation mode includes a calibration mode for executing calibration for the detection of the eye direction, and a measurement mode for a normal eye-direction detection. In the description below, the reference region is set as the set region, when the operation mode is the calibration mode, and the imaging region is set as the set region, when the operation mode is the measurement mode.

The reference image is an image displayed on the display screen 101 as an image indicating the range corresponding to the reference region. The reference image is displayed on the center of the display screen 101, for example. The display control unit 353-2 changes the color of the reference image according to the positional relationship, and displays the result on the display screen 101. The display manner is not limited to the color. Brightness may be changed.

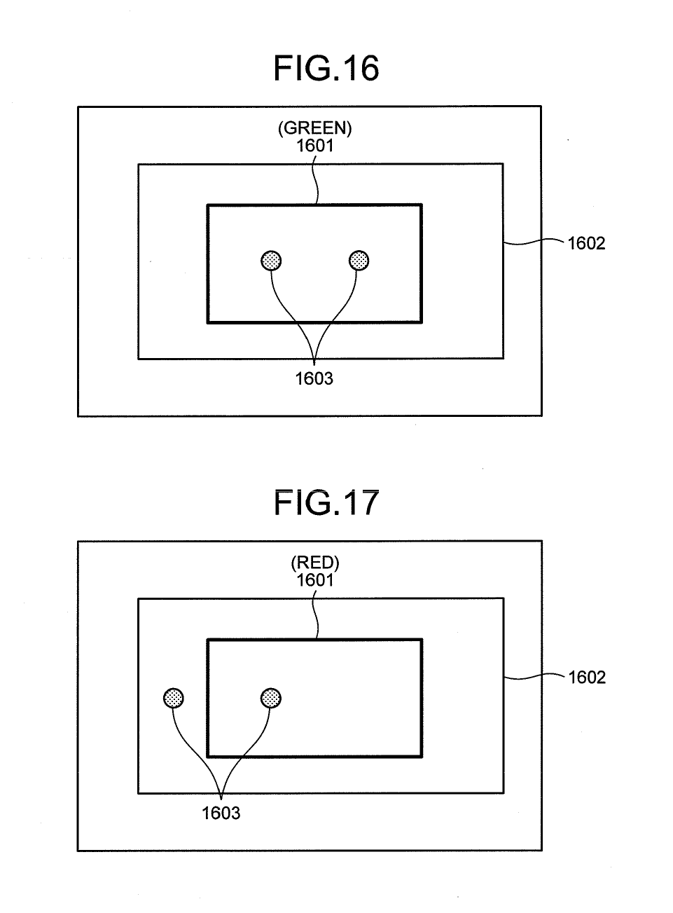

FIGS. 16 to 18 are views illustrating one example of a screen that displays the result of the detection as to whether the positional relationship between the subject and the stereo camera 102 is proper or not in the calibration mode. FIGS. 16 to 18 also illustrate that the color of the reference image (scale) indicating the range of the reference region is changed according to the positional relationship between the set region (in this embodiment, the reference region) and the eye position of the subject.

FIG. 16 is a view illustrating a display example of the display screen 101, when the positions of both eyes of the subject are within the reference region (=within the set region). The display screen displays a scale 1601 serving as the reference image, a frame 1602 serving as the imaging-range image, and an eye position image 1603. In this case, the display control unit 353-2 displays a green scale 1601.

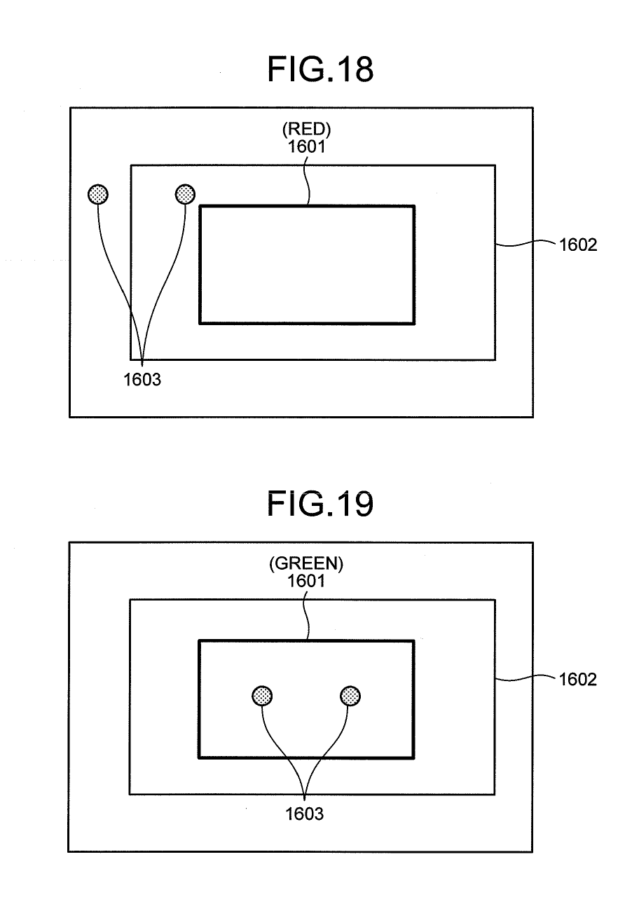

FIG. 17 is a view illustrating a display example of the display screen 101, when the position of one eye of the subject is out of the reference region (=out of the set region). In this case, the display control unit 353-2 displays the eye position image 1603 and a red scale 1601. FIG. 18 is a view illustrating a display example of the display screen 101, when the positions of both eyes of the subject are out of the reference region (=out of the set region). In this case, the display control unit 353-2 displays the eye position image 1603 and a red scale 1601.

FIGS. 19 to 21 are views illustrating one example of a screen that displays the result of the detection as to whether the positional relationship between the subject and the stereo camera 102 is proper or not in the measurement mode. FIG. 19 is a view illustrating a display example of the display screen 101, when the positions of both eyes of the subject are within the reference region (=within the imaging region, i.e., within the set region). The display screen displays a scale 1601 serving as the reference image, a frame 1602 serving as the imaging-range image, and an eye position image 1603. In this case, the display control unit 353-2 displays a green scale 1601.

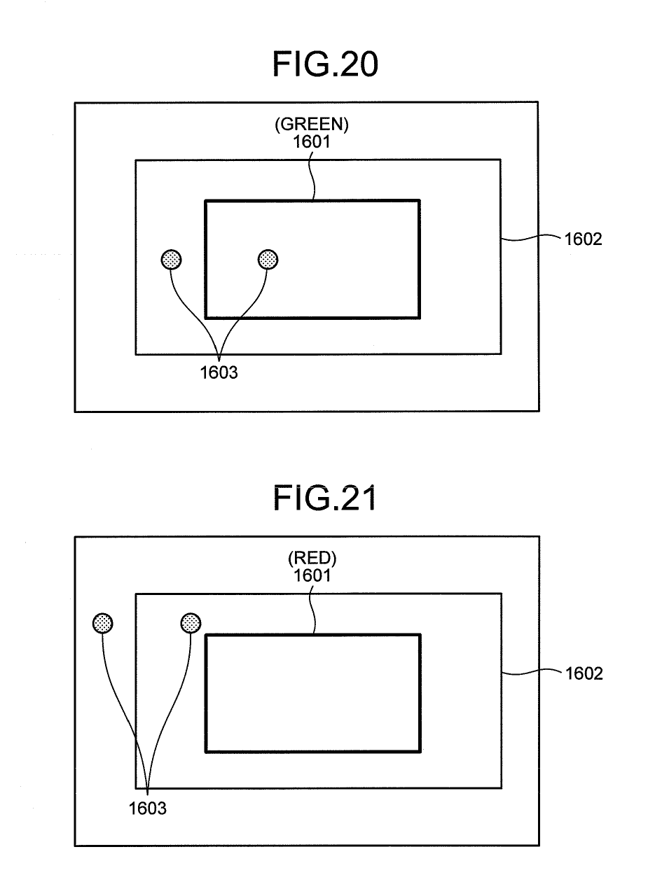

FIG. 20 is a view illustrating a display example of the display screen 101, when the position of one eye of the subject is out of the reference region, but the positions of both eyes are within the imaging region (=within the set region). In this case, the display control unit 353-2 displays the eye position image 1603 and a green scale 1601. FIG. 21 is a view illustrating a display example of the display screen 101, when the positions of both eyes of the subject are out of the imaging region (=out of the set region). In this case, the display control unit 353-2 displays the eye position image 1603 and a red scale 1601.

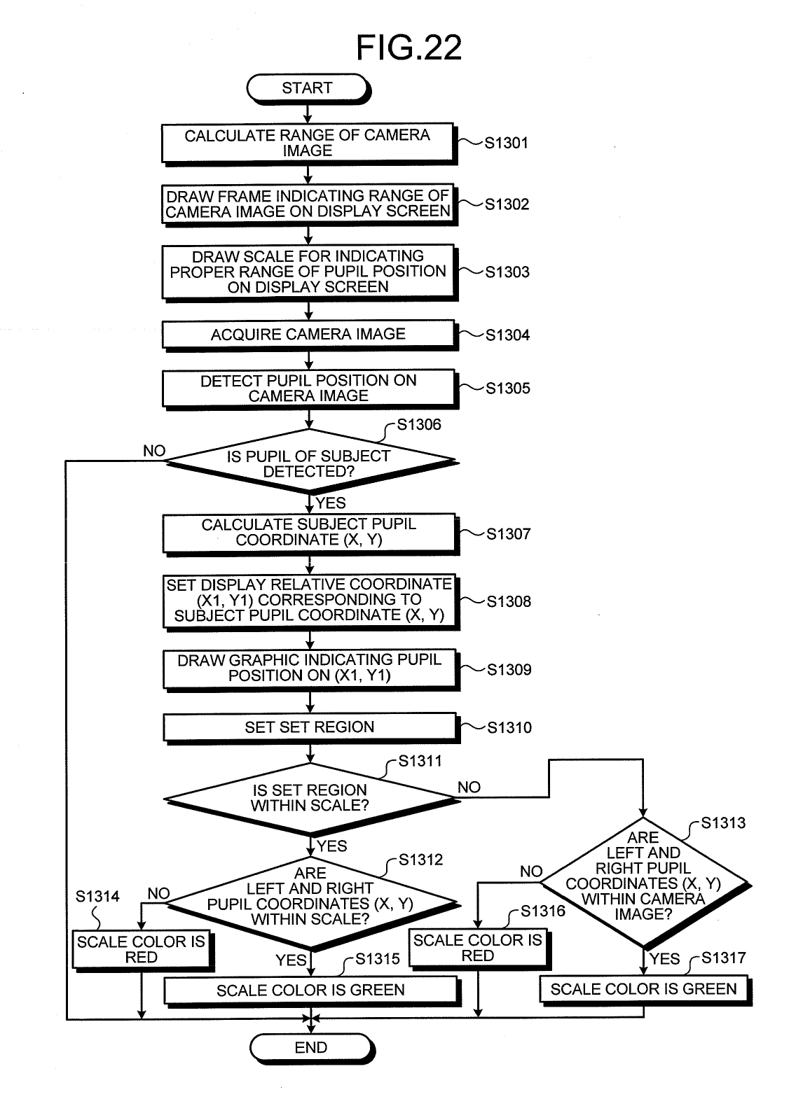

FIG. 22 is a flowchart illustrating one example of a display control process in the second embodiment.

Firstly, the display control unit 353-2 calculates the range of the camera image in the image displayed on the display screen 101 (step S1301). The display control unit 353-2 draws the frame 1602 (imaging-range image), indicating the range of the camera image, onto the display screen 101 (step S1302). The display control unit 353-2 draws the scale 1601 (reference image) for indicating the proper range of the pupil position on the display screen 101 (step S1303).

When the subject is on the position where he/she is caught by the stereo camera 102 in front of the display screen 101, the first detecting unit 351 acquires the camera image including the pupil image detected by the stereo camera 102 (step S1304). The first detecting unit 351 detects the pupil position in the camera image from the camera image (step S1305).

The first detecting unit 351 determines whether the pupil of the subject is detected or not from the camera image (step S1306). When the pupil of the subject is not detected because of the subject not being on a proper position or the like (step S1306: No), the display control process is ended.

When the pupil of the subject is detected (step S1306: Yes), the first detecting unit 351 calculates the pupil coordinate (X, Y) (step S1307). The display control unit 353-2 sets a display relative coordinate (X1, Y1) corresponding to the pupil coordinate (X, Y) of the subject in the frame 1602 of the imaging-range image (step S1308). The display control unit 353-2 draws a graphic (eye position image 1603) indicating the pupil position on the display relative coordinate (X1, Y1) (step S1309).

The display control unit 353-2 also sets the set region (step S1310). For example, the display control unit 353-2 sets the reference region as the set region in the calibration mode. In the measurement mode, the display control unit 353-2 sets the imaging region as the set region. The display control unit 353-2 determines whether the set region is in the range (reference region) of the scale 1601 or not (step S1311). This determination is equivalent to the determination as to whether the operation mode is the calibration mode or not.

When the set region is within the scale 1601 (step S1311: Yes), the display control unit 353-2 determines whether or not the pupil coordinates (X, Y) of both eyes are within the range of the scale 1601 (within the reference region) (step S1312). When the pupil coordinates (X, Y) of the right and left eyes are within the range of the scale 1601 (step S1312: Yes), the display control unit 353-2 displays the green scale 1601 on the display screen 101 (step S1315). When the pupil coordinates (X, Y) of the right and left eyes are not within the range of the scale 1601 (step S1312: No), the display control unit 353-2 displays the red scale 1601 on the display screen 101 (step S1314).

When the set region is not within the scale 1601 (step S1311: No), the display control unit 353-2 determines whether or not the pupil coordinates (X, Y) of both eyes are within the range of the camera image (within the imaging region) (step S1313). When the pupil coordinates (X, Y) of the right and left eyes are within the range of the camera image (step S1313 Yes), the display control unit 353-2 displays the green scale 1601 on the display screen 101 (step S1317). When the pupil coordinates (X, Y) of the right and left eyes are not within the range of the camera image (step S1313: No), the display control unit 353-2 displays the red scale 1601 on the display screen 101 (step S1316).

If a more correct pupil position is required like in such a case as the calibration for the eye-direction detection (in the calibration mode), the region suitable for shooting the eye portion is set as “the range of the scale 1601” (=reference region). When the two pupils are within the coordinate of the scale 1601 as illustrated in FIG. 16, the color of the scale 1601 is changed to green in order to indicate that the pupil position of the subject is on the proper position for the camera (step S1315). However, when one of the pupil positions is within the range of the camera, but is outside the proper position indicated by the scale 1601 as illustrated in FIG. 17, the color of the scale 1601 is changed to red in order to indicate that the pupil position of the subject is not on the proper position for the camera (step S1314). When the pupils of both eyes are outside the camera image as illustrated in FIG. 18, the color of the scale 1601 is similarly changed to red (step S1314). As described above, it is strictly determined that the pupil position of the subject is on the proper position with respect to the camera (stereo camera 102) during the calibration.

When a minimum pupil position is required as the case of the normal eye-direction detection (measurement mode), the region suitable for shooting the eye portion is set as the “range of the whole camera image” (=imaging region). When the two pupils are within the coordinate of the scale 1601 as illustrated in FIG. 19, the color of the scale 1601 is changed to green in order to indicate that the pupil position of the subject is on the proper position for the camera (step S1317). When one of the pupil positions is within the range of the camera, but is outside the proper position indicated by the scale 1601 as illustrated in FIG. 20, the color of the scale 1601 is also changed to green in order to indicate that the pupil position of the subject is on the proper position for the camera (step S1317). However, when one of the pupils is outside the range of the camera image as illustrated in FIG. 21, the detection of the eye direction is impossible. Therefore, the color of the scale 1601 is changed to red in order to indicate that the pupil position of the subject is not on the proper position for the camera (step S1316). The permissible range of the pupil position of the subject with respect to the camera is enlarged during the normal eye-direction detection as described above.

In the second embodiment, the criteria (set region) for determining whether the subject is on the proper position or not is changed according to the operation mode set beforehand and the subject can easily make the determination.

Modification 2

In FIGS. 16 to 21, examples of changing the color of the reference image (scale) indicating the range of the reference region are explained. The image whose display manner (color, etc.) is changed is not limited to the reference image. Any image may be used, so long as it can tell the subject that he/she is on the proper position. For example, the display manner of the imaging-range image or the eye position image may be changed. The display manner of plural images may be changed. For example, the display manner of at least one of the reference image, the imaging-range image, and the eye position image may be changed.

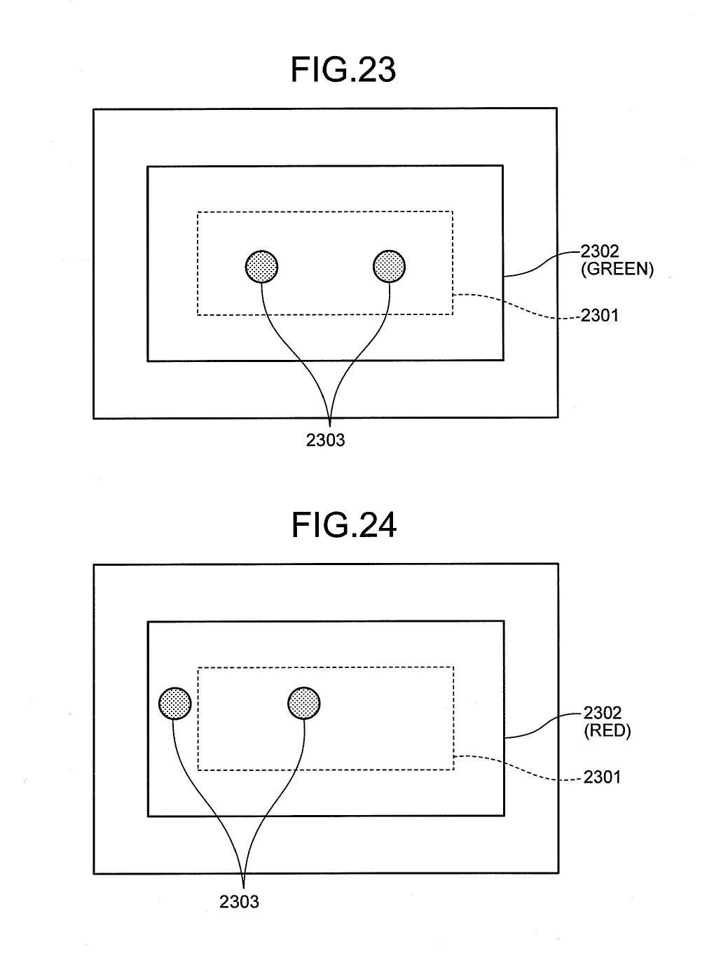

FIGS. 23 to 28 are views illustrating an example of a screen, when the color of the imaging-range image (the frame indicating the range of the camera image) is changed. FIGS. 23 to 25 are examples of illustrating that the imaging-range image is changed according to the positional relationship between the set region (=reference region) and the eye position of the subject in the calibration mode.

FIG. 23 is a view illustrating a display example of the display screen 101, when the positions of both eyes of the subject are within the reference region (=within the set region). The display screen displays a scale 2301, a frame 2302 serving as the imaging-range image, and an eye position image 2303. In this case, the display control unit 353-2 displays a green frame 2302.

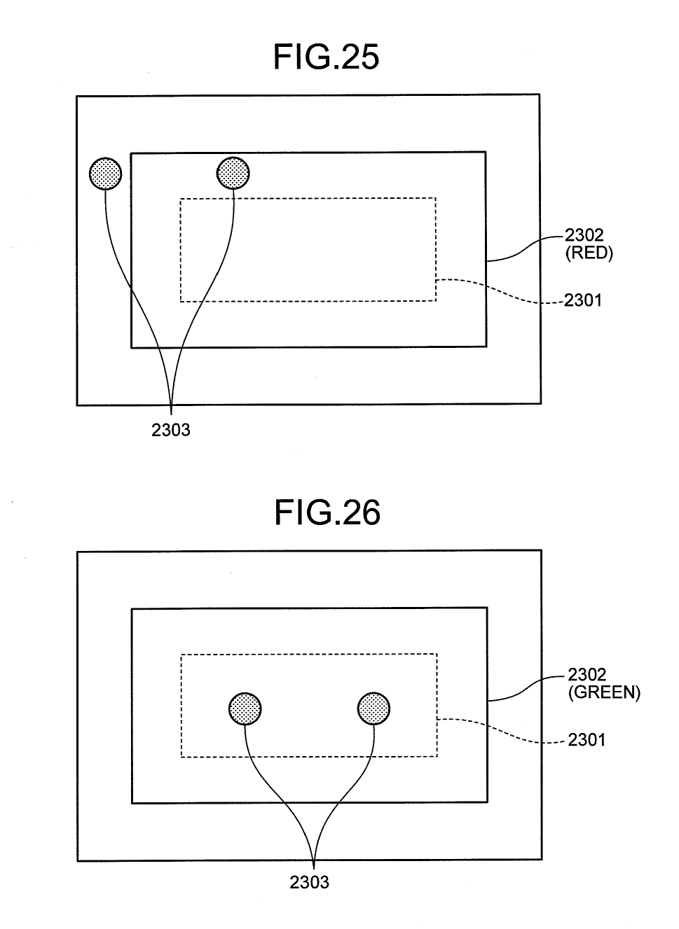

FIG. 24 is a view illustrating a display example of the display screen 101, when the position of one eye of the subject is out of the reference region (=out of the set region). In this case, the display control unit 353-2 displays the eye position image 2303 and a red frame 2302. FIG. 25 is a view illustrating a display example of the display screen 101, when the positions of both eyes of the subject are out of the reference region (=out of the set region). In this case, the display control unit 353-2 displays the eye position image 2303 and a red frame 2302.

FIGS. 26 to 28 illustrate that the imaging-range image is changed according to the positional relationship between the set region (=imaging region) and the eye position of the subject in the measurement mode.

FIG. 26 is a view illustrating a display example of the display screen 101, when the positions of both eyes of the subject are within the reference region (=within the imaging region, i.e., within the set region). The display screen displays the scale 2301 image, the frame 2302 serving as the imaging-range image, and the eye position image 2303. In this case, the display control unit 353-2 displays a green frame 2302.

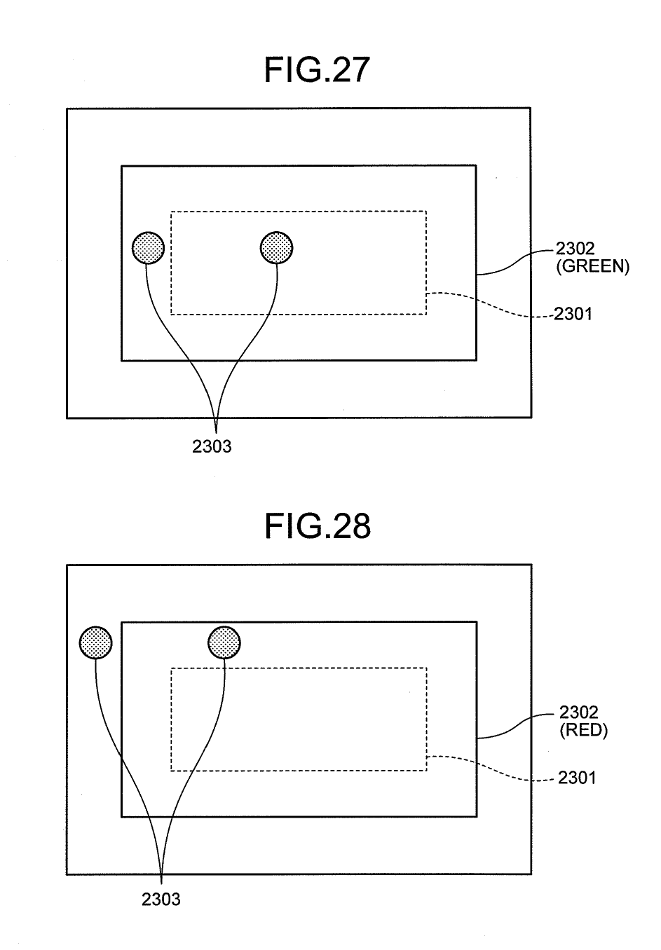

FIG. 27 is a view illustrating a display example of the display screen 101, when the position of one eye of the subject is out of the reference region, but the positions of both eyes are within the imaging region (=within the set region). In this case, the display control unit 353-2 displays the eye position image 2303 and a green frame 2302. FIG. 28 is a view illustrating a display example of the display screen 101, when the positions of both eyes of the subject are out of the imaging region (=out of the set region). In this case, the display control unit 353-2 displays the eye position image 2303 and a red frame 2302.

The second embodiment produces the effect described below, for example.

(1) The image indicating the eye is displayed with respect to the scale indicating the proper position. Therefore, the subject can determine whether he/she is on the proper position or not, and can adjust his/her position.
(2) When the subject is on the proper position, the color of the image representing the scale is changed. Therefore, the subject can instantaneously determine whether he/she is on the proper position or not, and can prepare for the start of the eye-direction detection.
(3) The detection is executed with the subject being on the proper position, whereby high precise detection result of the eye direction can be obtained.

The eye direction detecting apparatus and the eye direction detecting method according to the present invention brings an effect of enhancing detection precision.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An eye direction detecting apparatus comprising:
a display unit;
an imaging unit configured to image a subject;
a first detecting unit configured to detect a position of an eye of the subject from an image captured by the imaging unit;
a second detecting unit configured to detect a distance to the position of the eye of the subject from the imaging unit; and
a display control unit configured to display an image representing the position of the eye of the subject corresponding to the position of the eye detected by the first detecting unit onto the display unit with a display manner being changed according to the distance detected by the second detecting unit.

2. The eye direction detecting apparatus according to claim 1, wherein
the display control unit displays the image representing the position of the eye of the subject onto the display unit with the size of the image being changed according to the distance detected by the second detecting unit.

3. The eye direction detecting apparatus according to claim 2, wherein
the display control unit causes:
the display unit to display a marker corresponding to a size of the image indicating the position of the eye of the subject on a reference distance set beforehand;
the display unit to change the image indicating the position of the eye of the subject to be smaller than the marker and to display the resultant, when the distance detected by the second detecting unit is smaller than the reference distance; and
the display unit to change the image indicating the position of the eye of the subject to be larger than the marker and to display the resultant, when the distance detected by the second detecting unit is larger than the reference distance.

4. The eye direction detecting apparatus according to claim 1, wherein
the display control unit displays the image indicating the position of the eye of the subject on the display unit with its color or brightness being changed according to the distance detected by the second detecting unit.

5. The eye direction detecting apparatus according to claim 1, wherein
the display control unit displays a character or a graphic displayed on the display unit together with the image indicating the position of the eye of the subject, the character or graphic being changed according to the distance detected by the second detecting unit.

6. An eye direction detecting method comprising:
a position detecting step detecting a position of an eye of a subject from an image captured by an imaging unit that captures the subject;
a distance detecting step detecting a distance from the imaging unit to the position of the eye of the subject; and a display control step displaying an image indicating the position of the eye of the subject on the display unit with a display manner being changed according to the distance detected in the distance detecting step.
